(19) United States
(12) Patent Application Publication
(10) Pub. No.: US 2022/0000295 A1
(43) Pub. Date: Jan. 6, 2022

(54) ILLUMINATED SUPPORT, INFORMATION AND IDENTIFICATION ADDRESS POST

(71) Applicant: Robert Ward Sankey, Agua Dulce, CA (US)

(72) Inventor: Robert Ward Sankey, Agua Dulce, CA (US)

(21) Appl. No.: 17/358,813

(22) Filed: Jun. 25, 2021

Related U.S. Application Data
(60) Provisional application No. 63/047,552, filed on Jul. 2, 2020.

(51) Int. Cl. A47G 29/12; F21L 4/08; G09F 13/04; G09F 13/06; G09F 27/00

(52) U.S. Cl. CPC A47G 29/1216; F21L 4/08; G09F 27/007; G09F 13/0445; G09F 13/06; G09F 13/0422

(57) ABSTRACT

An extruded post used to support a sign, mailbox or set of rails, or in a stand-alone mode, with an interior light source to illuminate characters cut out of the wall of the post or rail for identification of a property or to transmit a message. The light source is inserted into the interior of the post or rail. A translucent sheet is placed within the wall of the post or rail and in front of the illumination source. A reflective backing, with a locking aspect, is inserted into the post or rail to reflect light from the light source thru the translucent sheet and thru the cut out characters. Power for the illumination is provided by a solar charged battery placed in a cap on top of the post. A processing unit is placed in line between the power source and the illumination to generate light patterns and effects.

### CROSS REFERENCE OF RELATED APPLICATIONS

This application claims the benefits of U.S. provisional application No. 63/047,552, filed Jul. 2, 2020 and entitled ILLUMINATED SUPPORT, INFORMATION AND IDENTIFICATION ADDRESS POST, which provisional application is incorporated by reference herein in its entirety.

### FIELD OF THE INVENTION

The present invention relates generally to an illuminated support, information and identification address post, and more particularly, to an illuminated address post that is attractive, simple to construct, low cost and easily maintained and also uses solar energy as a power source.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, house numbers are in common use for identifying residence and business locations; however, residences in rural locations, even with a house number, are often difficult and time consuming to locate. Emergency response times can be greatly reduced by the quick and proper identification of a properties location by use of a visible address.

To solve the above-mentioned problem, several types of illuminated posts have been proposed—for example U.S. Pat. No. 6,017,131 (Goins), U.S. Pat. No. 7,310,901 (Estes), U.S. patent publication 20040083634 (Blsson et al.), 20070241922 (Brannon). However, those are not easy to manufacture since they have many components to deal with.

Therefore, how to solve the above-mentioned problem is a topic that relevant manufacturers in this industry urgently want to study and improve.

### SUMMARY

In order to solve the problem above, the present invention provides an illuminated support, information and identification address post, which is easier to manufacture and assemble.

An illuminated post, comprising:
an elongate post having an interior space, a top end, and a ground engaging bottom end, and a length extending between the top end and the ground engaging bottom end;
a plurality of indicium cutouts locates at a surface of the elongate post;
a light source for illuminating the indicium cutouts, wherein the light source is mounted adjacent to the indicium cutouts, within the elongate post, and acts as an illuminator for the indicium cutouts, wherein light from the light source emits therefrom;
a translucent sheet located behind the indicium cutouts and in front of the light source;
a backing plate, which can reflect light thru the indicium cutouts, with a locking mechanism to locate the light source, the translucent sheet and the backing plate into position within the elongate post;
a battery for supplying power to the light source;
a cap for covering the top end of the elongate post, the cap having a groove and downwardly sloping surfaces, the downwardly sloping surfaces being used as a protective roof for said light source; and
a solar cell in the groove of the cap for receiving light to recharge the battery during daylight hours.

In another aspect, an elongate arm coupled to the elongate post, the elongate arm is for coupling a mail box thereto.

In another aspect, the indicium cutouts arranged vertically on the surface of the elongate post.

In another aspect, a plurality of slots are located at the surface of the elongate post for the mounting of a plurality of fence rails having an interior space, a front wall, a back wall, bottom wall and top wall.

In another aspect, an elongate arm coupled to the elongate post, the elongate arm is for coupling a sign thereto.

In another aspect, the elongate post is constructed of plastic, vinyl, polyvinyl chloride (PVC), synthetic material, man-made material, natural material or a combination of synthetic and natural materials.

In another aspect, the light source is controlled by a processor such that the light source may be varied in its output.

In another aspect, the present invention further comprising an alternative power source, which is installed in the elongate post and connected to the battery, or connected to the battery through a wire from outside the elongate post, to recharge the battery during daylight hours.

In different embodiment, the present invention further comprising an alternative power source, which is installed in the elongate post and connected to the light source, or connected to the light source through a wire from outside the elongate post, to directly power the light source.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 shows a first embodiment of a stand-alone marker post with the interior workings exposed;

FIG. 2 shows a mailbox with the supporting post and a remote power source;

FIG. 3 shows a corner fence post with signage on the post and a remote solar panel;

FIG. 4 shows a corner fence post with signage on the rails and a post cap solar power source;

FIG. 5 shows a Real Estate sign with supporting post and a post cap solar power source;

FIGS. 6a and 6b show a first embodiment of the extrusion patterns for the post and the rail;

FIG. 7 shows a schematic of the electrical system;

FIG. 8 shows a second embodiment of a stand-alone marker post with the interior workings exposed;

FIGS. 9a and 9b shows a second embodiment of the extrusion patterns for the post and the rail;

Like reference numerals refer to like parts throughout the various views of the drawings.

### DETAILED DESCRIPTION OF THE INVENTION

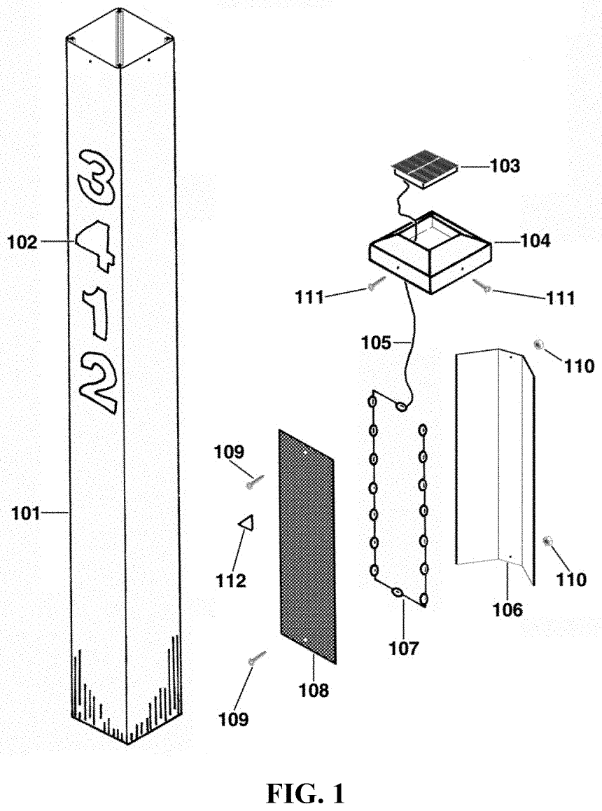

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

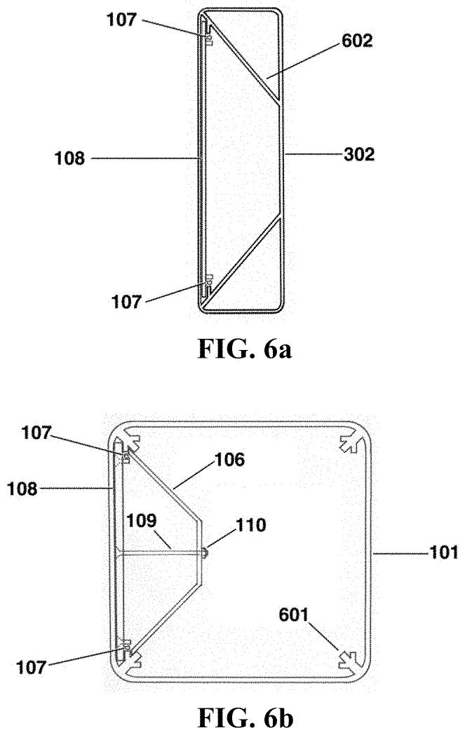

FIG. 1 shows a stand-alone post 101 generally hollow and square in shape that is in the nature of an extruded square tube of varying dimension that may be formed of PVC or other suitable material. The post 101 further includes a plurality of digits, characters or graphical designs 102, with floating elements, cut or routed thru one or more vertical surfaces using a router or other cutting method attached to a pantograph, CNC or similar type tool. A plurality of extruded patterns, as shown in FIGS. 6a and 6b, is used to support the internal elements which consist of, but are not limited to, a translucent sheet 108 which shall be placed behind the digits, characters or graphical designs (indicium cutouts) 102 that allows the light from a plurality of lamps 107, said lamps used in conjunction with the appropriate type current and voltage source. Said translucent sheet will also act as a support for floating elements 112 of the digits, characters or graphical designs 102 to be attached. A back plate 106 attached to the translucent sheet with a plurality of bolts 109 and nuts 110 which shall pull the back plate 106 against the inner extrusion of post 101 thereby locking the complete lamp unit, consisting of items 106, 107, 108, 109, 110 and 112 inclusively, in place within post 101. The cap 104, which is used to protect the internal elements and to hold the solar panel, power switch, photoelectric switch and battery pack 103 which is commercially available and is connected to the lamps 107 with an electrical transmission wire 105. The cap 104 shall be attached with a plurality of fasteners 111 to said post 101.

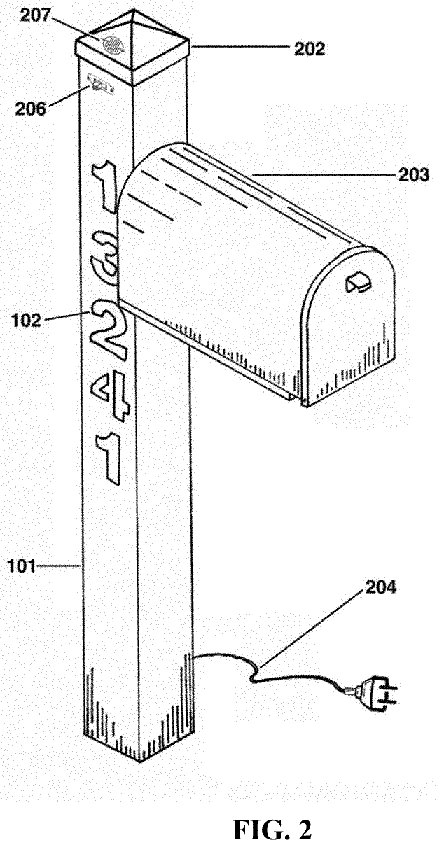

FIG. 2 shows a mailbox support post 101 that is with sufficient strength to support the mailbox 203. Said post with internal construction, as shown in FIG. 1, FIG. 6a and FIG. 6b. Said post having a plurality of digits, characters or graphical designs 102 cut or routed thru one or more vertical surfaces. Said design 102 may be cut in the form of a stencil such that there are no floating members such as shown in FIG. 1 elements 102 and 112. There is a cap 202 to protect the internal elements attached with a plurality of fasteners, as shown in FIG. 1, to said post 101 and a source of power 204, of appropriate current and voltage for the internal light source such as shown in FIG. 1. A power switch 206 and a photovoltaic switch 207 may be used to control the integrated light unit.

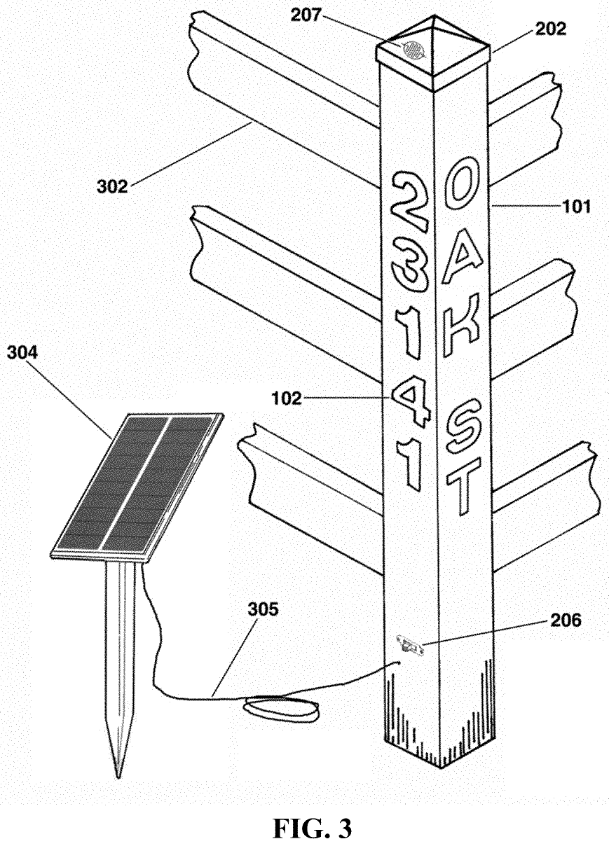

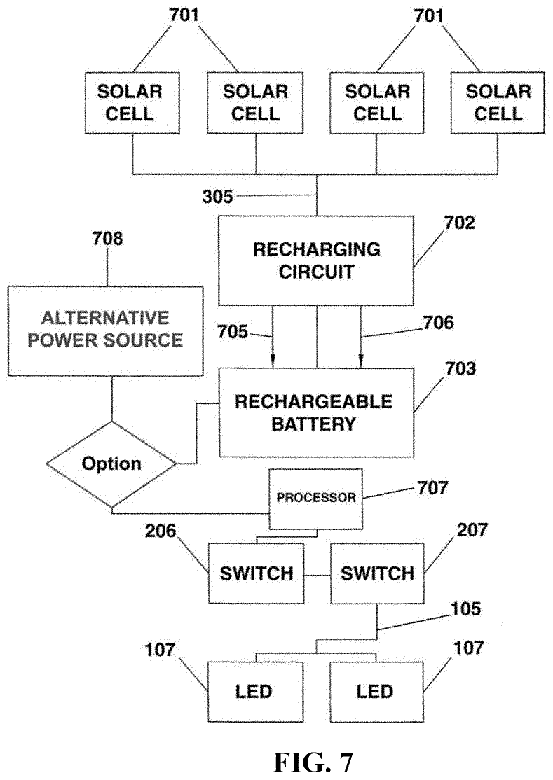

FIG. 3 shows a corner fence post 101 and a plurality of fence rails 302, generally hollow and rectangular in shape, extending from one or more directions. Said post with internal construction, as shown in FIG. 1, FIG. 6a and FIG. 6b. Said post with a remote solar panel 304 with a connecting power cord 305 leading to a rechargeable battery pack 703 as shown in FIG. 7. Also shown connected in line 305 is a photoelectric cell 207 that may be adjusted to receive sunlight and form an appropriate electrical switch when the sunlight reaches a certain level. In other words, the photoelectric cell 207 may be adjusted for an appropriate level of sunlight at which internal lamps 107 will be caused to receive electrical energy. A switch 206 may be also included between the battery pack 322 and the light source 107 allowing the user to switch the lamps on or off.

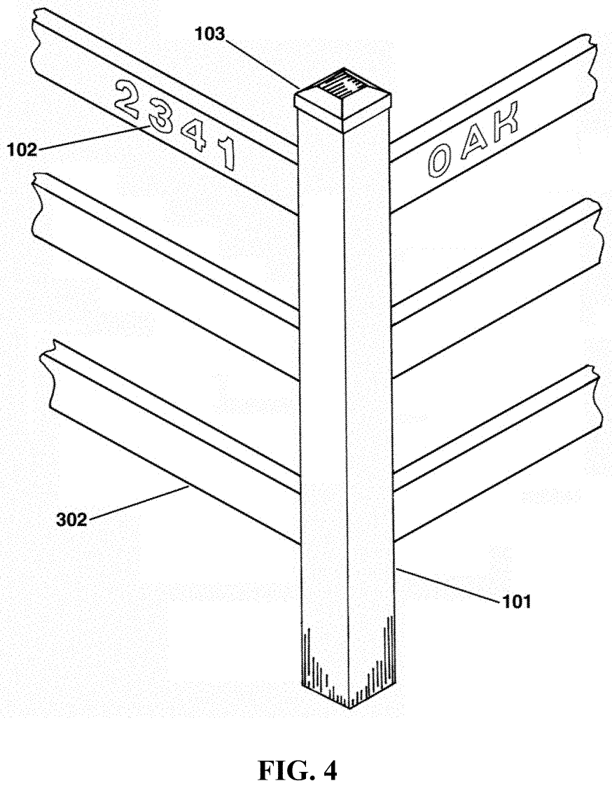

FIG. 4 shows a support post 101 with a plurality of fence rails 302 with internal extruded construction as shown in FIG. 6a and FIG. 6b, with a plurality of digits, characters or graphical designs (second indicium cutouts) 102 cut or routed thru one or more vertical surfaces as per FIG. 1 with cap 103 which is used to protect the internal elements and to hold the solar panel, power switch, photoelectric switch and battery pack as described in FIG. 1 and FIG. 7. In addition, a second light source (not shown in the figure) for illuminating the second indicium cutouts 102 wherein the second light source is mounted adjacent to the second indicium cutouts 102, within the fence rail 302, and acts as an illuminator for the second indicium cutouts 102, wherein light from the second light source emits therefrom.

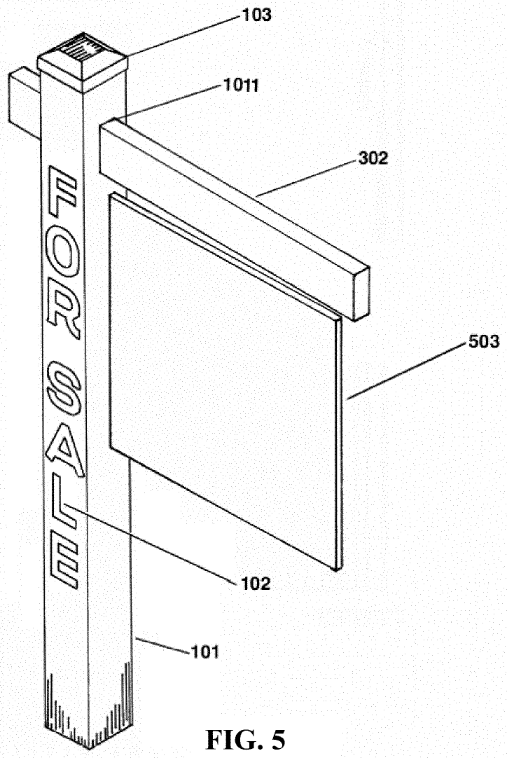

FIG. 5 shows a support post 101 with a plurality of digits, characters or graphical designs 102 cut or routed thru one or more vertical surfaces as per FIG. 1, and a plurality of slots 1011 are located at the surface of the elongate post for the mounting of a cross bar 302, of a similar manufacture and material as stated above, used to support a sign 503 such as that used in the Real Estate or other various industries. A cap 103, which is used to protect the internal elements and to hold the solar panel, power switch, photoelectric switch, and battery pack as described in FIG. 1 and FIG. 7.

FIG. 6a shows the extrusion pattern for rail 302 with the translucent sheet 108 such that it is sandwiched between the outer portion of rail 302 and the interior extruded baffles and tabs 602 of rail 302 and will be attached in the appropriate position, by adhesive or other means, behind the cutout indicium designs 102 as shown in FIG. 4. The lamps 107 shall be attached around the periphery of the translucent sheet 108 such that illumination from the lamps 107 shall reflect against said baffle 602 and project thru the indicium cutout 102 of FIG. 4.

FIG. 6b shows the extrusion pattern for post 101 with the translucent sheet 108 such that said translucent sheet is sandwiched between the outer portion of the post 101 and the interior extruded tabs 601 of post 101 placed behind the cutout indicium designs 102 as shown in FIG. 1 thru FIG. 5. Tension shall be applied by tightening nut 110 to the bolt 109 thereby pulling the back plate 106 towards the wall of the post 101 pressing the edges of the back plate 106 to press against the extruded tabs 601 of tube 101 thereby securing the lamp unit to the interior of the body of post 101, and the extruded tabs 601 is shaped like a trident and both edges of the back plate 106 is inserted and pressed between two of the raised parts of the trident to be well fixed. The lamps 107 shall be attached around the periphery of the translucent sheet 108 such that illumination from the lamps 107 shall reflect against said backing plate 106 and project thru the indicium cutout 102 of FIG. 1 thru FIG. 5. Said post 101 to be so constructed to allow a plurality of lamp units to be placed with up to four directional aspects in relation to the faces of the post 101 creating one or more illuminated faces.

FIG. 7 shows the electrical circuitry of the light unit. As shown therein, solar cells 701 are connected by electrical transmission wire 305 to recharging circuit 702. The recharging circuit is in turn connected to rechargeable battery 703, which is connected to processor unit 707 which is connected to manual switch 206 which is connected to photovoltaic switch 207 which is connected by electrical transmission wire 105 to a plurality of LED's or other lamps or illumination devices 107. Said processor may alternately be attached to another type of power source 708 as described previously, that is, the alternative power source 708 can be another solar cell(s) for receiving light to recharge the battery 703, or the alternative power source 708 can just act as another battery and directly give the power to processor 707, and the alternative power source 708 can be any kind of source, like 120VAC, 12VAC or DC, etc. Furthermore, the alternative power source 708 can be installed in the elongate post 101 and connected to the battery 703, or connected to the battery 703 through a wire from outside the elongate post 101, to recharge the battery 703 during daylight hours. In other embodiments, the alternative power source 708 might be installed in the elongate post 101 and directly connected to the light source 107, or directly connected to the light source 107 through a wire from outside the elongate post 101, to directly power the light source 107.

In operation, during daylight hours, solar cells collect Solar energy and convert that energy to electric power, which is delivered to recharging circuit 705. The recharging circuit includes conventional electronic components, known to persons skilled in the art, which deliver a recharging input 706 to rechargeable battery 703. The recharging circuit may also include components that deactivate the lamps during daylight hours when lamp operation is not required. For example, as the Solar cells 701 deliver recharging power to circuit 702, a sensing Voltage may be developed in the recharging circuit. This Voltage may provide a signal 706 to recharging battery 703, which directs the battery to operatively disconnect from the lamps 107. As a result, the light unit is deactivated.

Alternatively manual switch 206 allows the user to disconnect the rechargeable battery 703 from the lamps 107 such that the lamps will not illuminate. Alternatively, during evening hours or during other times of relative low light or darkness, when switch 206 is in the on position, photovoltaic cell 207 completes the circuit between the rechargeable battery 703 and the lamps 107. This causes the rechargeable battery 703 to reconnect with the lamps 107 and to release power to the lamps, which energizes and illuminates the light unit. Processor unit 707 creates a plurality of patterns and visual effects in the output of the lamps or illumination devices 107.

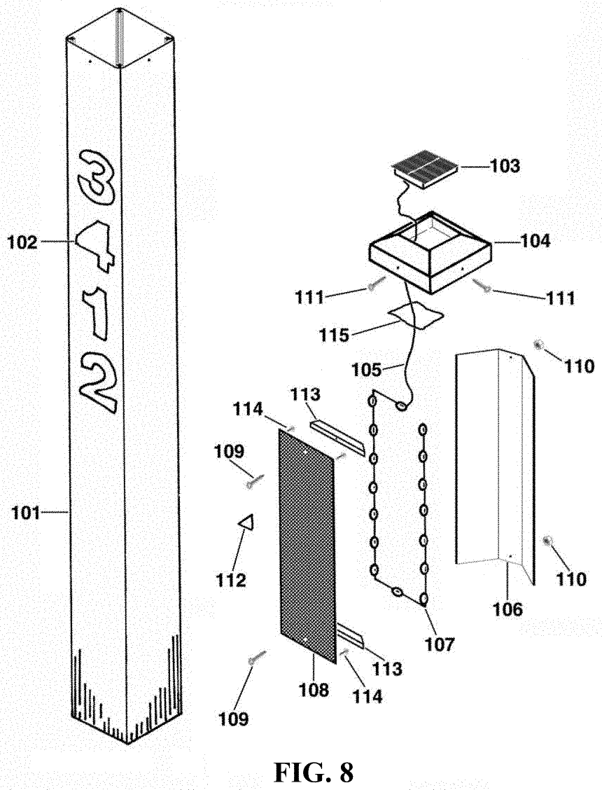

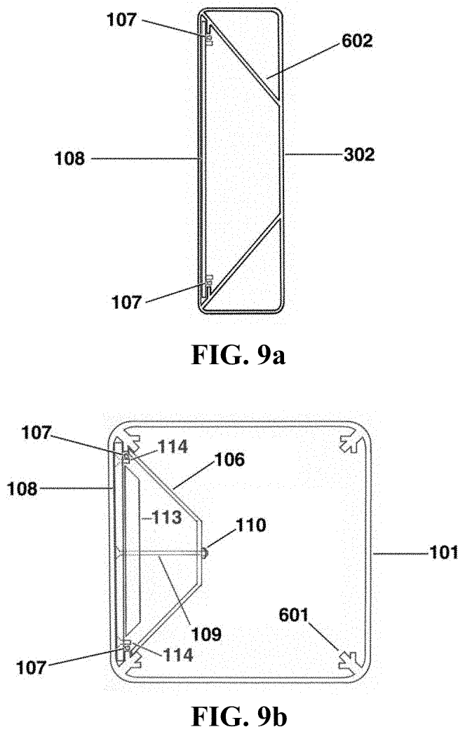

FIG. 8 shows a second embodiment of a stand-alone post 101 generally hollow and square in shape that is in the nature of an extruded square tube of varying dimension that may be formed of PVC or other suitable material. The post 101 is further includes a plurality of digits, characters or graphical designs 102, with floating elements, cut or routed thru one or more vertical surfaces using a router or other cutting method attached to a pantograph, CNC or similar type tool. A plurality of extruded patterns, as shown in FIGS. 9a and 9b, is used to support the internal elements which consist of, but are not limited to, a translucent sheet 108 which shall be placed behind the digits, characters or graphical designs 102 that allows the light from a plurality of lamps 107, said lamps used in conjunction with the appropriate type current and voltage source. A plurality of posts 114 attached about the perimeter of the said translucent plate for the attachment of said lamps. Said translucent sheet will also act as a support for floating elements 112 of the digits, characters or graphical designs 102 to be attached. A reflective backing plate 106 attached to the translucent sheet with a plurality of bolts 109 and nuts 110 which shall pull the said reflective backing plate against the inner extrusion of post 101 thereby locking the complete lamp unit, consisting of items 106, 107, 108, 109, 110, 112 and 113 inclusively, in place within post 101. A stiffener 113 is adhered to said translucent plate providing rigidity to said translucent plate. The cap 104, which is used to protect the internal elements and to hold the solar panel, power switch, photoelectric switch and battery pack 103 which is commercially available and is connected to the lamps 107 with an electrical transmission wire 105 and is secured to said cap with retainer 115. Said cap shall be attached with a plurality of fasteners 111 to said post.

FIG. 9a shows the second embodiment of the extrusion pattern for rail 302 with the translucent sheet 108 such that it is sandwiched between the outer portion of rail 302 and the interior extruded baffles and tabs 602 of rail 302 and will be attached in the appropriate position, by adhesive or other means, behind the cutout indicium designs 102 (like the one shown in FIG. 4). The lamps 107 shall be attached around the periphery of the translucent sheet 108 such that illumination from the lamps 107 shall reflect against said baffle 602 and project thru the indicium cutout 102 (like the one shown in FIG. 4).

FIG. 9b shows the second embodiment of the extrusion pattern for post 101 with the translucent sheet 108 such that said translucent sheet is sandwiched between the outer portion of the post 101 and the interior extruded tabs 601 of said post placed behind the cutout indicium designs 102 (like the one shown in FIG. 1 thru FIG. 5). Tension shall be applied by tightening nut 110 to the bolt 109 thereby pulling the reflective back plate 106 towards the wall of the post 101 pressing the edges of the back plate 106 to press against the extruded tabs 601 of tube 101 thereby securing the lamp unit to the interior of the body of post 101, and the extruded tabs 601 is shaped like a trident and both edges of the back plate 106 is inserted and pressed between two of the raised parts of the trident to be well fixed. Stiffener 113 shall be adhered to said translucent sheet to provide rigidity. The lamps 107 shall be attached around the periphery of the translucent sheet 108 with guide posts 114 such that illumination from the lamps 107 shall reflect against said reflective backing plate 106 and project thru the indicium cutout 102 (like the one shown in FIG. 1 thru FIG. 5). Said post 101 to be so constructed to allow a plurality of lamp units to be placed with up to four directional aspects in relation to the faces of the post 101 creating one or more illuminated faces.

It should be understood, in alternative embodiments, various other means may be utilized to activate and deactivate the light source during periods of darkness and daylight respectively. For example, an optical sensor and/or microprocessor may be utilized to activate and deactivate the lights as required. Recharging circuits of the type used for circuit 702 are known for other outdoor lighting operations and will be understood by persons skilled in the art.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An illuminated post, comprising:
an elongate post having an interior space, a top end, and a ground engaging bottom end, and a length extending between the top end and the ground engaging bottom end;
a plurality of indicium cutouts locates at a surface of the elongate post;
a light source for illuminating the indicium cutouts, wherein the light source is mounted adjacent to the indicium cutouts, within the elongate post, and acts as an illuminator for the indicium cutouts, wherein light from the light source emits therefrom;
a translucent sheet located behind the indicium cutouts and in front of the light source;
a backing plate, which can reflect light thru the indicium cutouts, with a locking mechanism to locate the light source, the translucent sheet and the backing plate into position within the elongate post;
a battery for supplying power to the light source;
a cap for covering the top end of the elongate post, the cap having a groove and downwardly sloping surfaces, the downwardly sloping surfaces being used as a protective roof for said light source; and
a solar cell in the groove of the cap for receiving light to recharge the battery during daylight hours.

2. The illuminated post of claim 1, wherein an elongate arm coupled to the elongate post, the elongate arm is for coupling a mail box thereto.

3. The illuminated post of claim 1, wherein the indicium cutouts arranged vertically on the surface of the elongate post.

4. The illuminated post of claim 1, wherein a plurality of slots are located at the surface of the elongate post for the mounting of a plurality of fence rails having an interior space, a front wall, a back wall, bottom wall and top wall.

5. The illuminated post of claim 4, wherein the fence rail has a plurality of second indicium cutouts across a horizontal face of the fence rail; and a second light source for illuminating the second indicium cutouts wherein the second light source is mounted adjacent to the second indicium cutouts, within the fence rail, and acts as an illuminator for the second indicium cutouts, wherein light from the second light source emits therefrom.

6. The illuminated post of claim 1, wherein an elongate arm coupled to the elongate post, the elongate arm is for coupling a sign thereto.

7. The illuminated post of claim 1, wherein the elongate post is constructed of plastic, vinyl, polyvinyl chloride (PVC), synthetic material, man-made material, natural material or a combination of synthetic and natural materials.

8. The illuminated post of claim 1, wherein the light source is controlled by a processor such that the light source can be varied in its output.

9. The illuminated post of claim 1, further comprising an alternative power source, which is installed in the elongate post and connected to the battery, or connected to the battery through a wire from outside the elongate post, to recharge the battery during daylight hours.

10. The illuminated post of claim 1, further comprising an alternative power source, which is installed in the elongate post and connected to the light source, or connected to the light source through a wire from outside the elongate post, to directly power the light source.
